(19) United States
(12) Patent Application Publication
(10) Pub. No.: US 2018/0133764 A1
(43) Pub. Date: May 17, 2018

(54) STREAMLINE HOOD AND ENCLOSURE FOR WORK STATIONS

(71) Applicant: ROBOVENT PRODUCTS GROUP, INC., Sterling Heights, MI (US)

(72) Inventor: JOHN REID, TROY, MI (US)

(21) Appl. No.: 15/812,961

(22) Filed: Nov. 14, 2017

Related U.S. Application Data
(60) Provisional application No. 62/421,539, filed on Nov. 14, 2016.

(51) Int. Cl. B08B 15/02; F24F 3/16

(52) U.S. Cl. CPC B08B 15/02; F24F 3/1603

(57) ABSTRACT

The workstation of the present invention has a hood structure, vertical supports supporting the hood above the ground and cross supports adding strength to the structure and providing structure for mounting lights etc. The hood has at least two opposed rails, and in the disclosed embodiment four rails with each rail having a multi-purpose profile. The multi-purpose profile is generally U-shaped with a top wall, a side wall, and a bottom wall. A top flange extends generally perpendicular to the top wall and a bottom flange extends generally perpendicular to the bottom wall. The top flange and bottom flange extend generally parallel to one another and are spaced apart by a first distance. A lip extends generally perpendicular to the flange. The lip is generally parallel to the bottom wall and is spaced from the bottom wall by a second distance. The vertical supports have a width that is generally equal to the first distance such that the vertical supports can be positioned between the top flange and the bottom flange. The cross supports have a width generally equal to the second distance such that the cross supports can be positioned between the lip and the bottom wall.

### CROSS-REFERENCE TO RELATED APPLICATIONS

This utility application claims the benefit of U.S. Provisional Application No. 62/421,539 filed Nov. 14, 2016. The entire disclosure of the above application is incorporated herein by reference.

### TECHNICAL FIELD

The present invention generally relates to enclosures for workstations and in particular to enclosures for workstations that are connected to a collector that draws air from the enclosure and filters that air before returning it to the environment.

### BACKGROUND OF THE INVENTION

Workstations incorporating air filtering systems are known and used in a variety of industries. In many manufacturing industries, processes such as welding generate undesirable byproducts such as dust or other substances. Separate workstations or work areas are often used to contain these substances produced during manufacturing operations. A collector or air filter system in operatively connected to the workstation and pulls the air from the station through a series of filters and then returns filtered air to the environment.

The size and configuration of workstation air filtering operations can vary from small hood style arrangements to full room enclosures. In some instances the workstations or room enclosures are required to be portable. This feature allows them to be erected surrounding equipment at a given site and in addition to be moved to accommodate assembly line reconfigurations. Known structures, however, allow for relatively limited reconfigurations from their original designs. This can restrict their usage, such as when their configuration is not compatible with assembly line space limitations.

In addition, workstations with restrained design modifications may not be compatible with other production layouts and overhead equipment. It would therefore be highly desirable to have a workstation assembly that was modular in nature and could quickly and efficiently accommodate varied enclosure size and configuration. It would also be desirable to have a workstation assembly that has a low profile top to reduce overall height.

Additionally, it is desirable to have a workstation enclosure that is easily shipped to a job site and easily assembled. To make shipping easier and less costly, the workstation needs to be shipped in pieces that are generally flat and can be bundled together. To make assembly easier, the workstation enclosure needs to have a minimum number of components that can be assembled to form a strong durable structure.

### SUMMARY OF THE INVENTION

The workstation of the present invention has a hood structure, vertical supports supporting the hood above the ground and cross supports adding strength to the structure and providing structure for mounting lights etc. The hood has at least two opposed rails, and in the disclosed embodiment four rails with each rail having a multi-purpose profile. These rails can be easily cut to desired sizes, manufactured to any desired length or connected together, making the workstation flexible for any desired size surrounding to be enclosed.

The multi-purpose profile is generally U-shaped with a top wall, a side wall, and a bottom wall. A top flange extends generally perpendicular to the top wall and a bottom flange extends generally perpendicular to the bottom wall. The top flange and bottom flange extend generally parallel to one another and are spaced apart by a first distance. A lip extends generally perpendicular to the flange. The lip is generally parallel to the bottom wall and is spaced from the bottom wall by a second distance.

The vertical supports have a width that is generally equal to the first distance such that the vertical supports can be positioned between the top flange and the bottom flange. The cross supports have a width generally equal to the second distance such that the cross supports can be positioned between the lip and the bottom wall.

In this way, the workstation is easy to assemble by inserting the vertical supports between the top flange and the bottom flange and inserting the cross supports between the lip and the bottom wall. If desired, fasteners can be used to securely fasten the supports in place.

The present invention is a unique solution for enclosing workstations and in particular for example robotic welding cells or welding cells having human welders inside. The modular hood system of the present invention covers a work station, such as for example a welding cell and captures the weld fumes for conveyance through for example a duct work system or direct mounting to a connected collector. In the collector, weld fumes are sent through high-efficiency filters, removing airborne contaminants and returning filtered air to the plant.

The hood of the present invention can be installed on site, and is custom sized to exactly fit over the weld cell it covers. The hood is slimmer and more efficient, taking up less space while delivering major benefits. The hood can accommodate for example single or multiple robot systems or other material processing equipment with a variety of configurations, including turntable, ferris wheel or headstock/tailstock tooling configurations. It can also house one or more human welders or processing people. The unit's low profile is particularly advantageous for facilities with overhead cranes. A transparent top also allows light into the enclosure. Interior cross-supports can accommodate lighting fixtures or other attachments if desired.

The work station of the present invention ships flat for easy transport, delivery and storage. The modular design uses economical standardized parts that can be easily assembled, disassembled and reused. Installation and modifications are quick and easy.

Further areas of applicability will become apparent from the description provided herein. The description and specific examples in this summary are intended for purposes of illustration only and are not intended to limit the scope of the present disclosure.

### DESCRIPTION OF THE DRAWINGS

Other advantages of the present invention will be readily appreciated, as the same becomes better understood by reference to the following detailed description when considered in connection with the accompanying drawings. The drawings described herein are for illustrative purposes only of selected embodiments and not all possible implementations, and are not intended to limit the scope of the present disclosure, wherein:

FIG. 1 is a partial perspective view of the streamlined hood and enclosure for a workstation of the present invention.

FIG. 2 is a partial perspective view of a multi-purpose profile rail of the present invention.

FIG. 3 is a partial perspective view of the interior of the streamlined hood and enclosure for a workstation of the present invention.

FIG. 4 is a partial perspective view of the interior of the streamlined hood and enclosure for a workstation of the present invention.

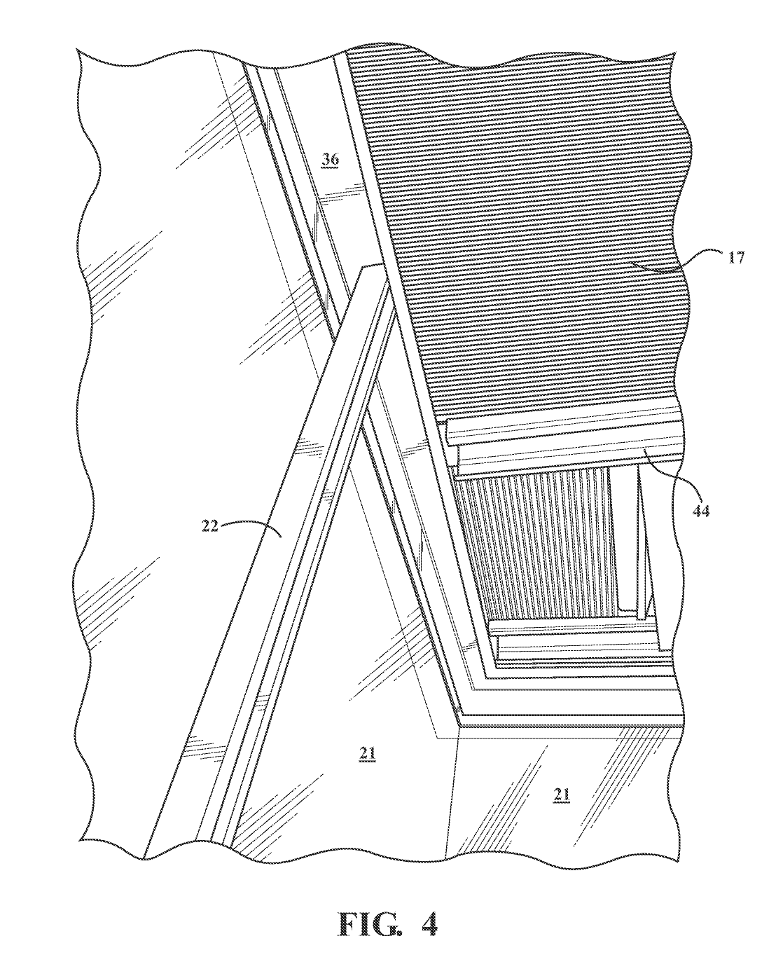

FIG. 5 is a partial perspective view of the top of the streamlined hood and of the present invention.

### DETAILED DESCRIPTION OF THE INVENTION

The present invention is a unique solution for enclosing workstations 10 and in particular robotic welding cells 10. The modular hood system 16 of the present invention covers a work station, such as for example a welding cell and captures the weld fumes for conveyance through a duct work system 11 to a connected collector or to an attached collector. In the collector, weld fumes are sent through high-efficiency filters, removing airborne contaminants and returning cleaner air to the plant.

The hood 16 of the present invention can be installed on site, and is custom sized to exactly fit over the weld cell it covers. The hood is slimmer and more efficient, taking up less space while delivering major benefits. The hood 16 can accommodate single or multiple robot systems or other material processing systems or operations conducting by people with a variety of configurations, including turntable, ferris wheel or headstock/tailstock tooling configurations. The unit's low profile is particularly advantageous for facilities with overhead cranes. A transparent top allows light into the enclosure. Interior cross-supports 20 can accommodate lighting fixtures.

The work station 10 of the present invention ships flat for easy transport, delivery and storage. The modular design uses economical standardized parts that can be easily assembled, disassembled and reused. Installation and modifications are quick and easy.

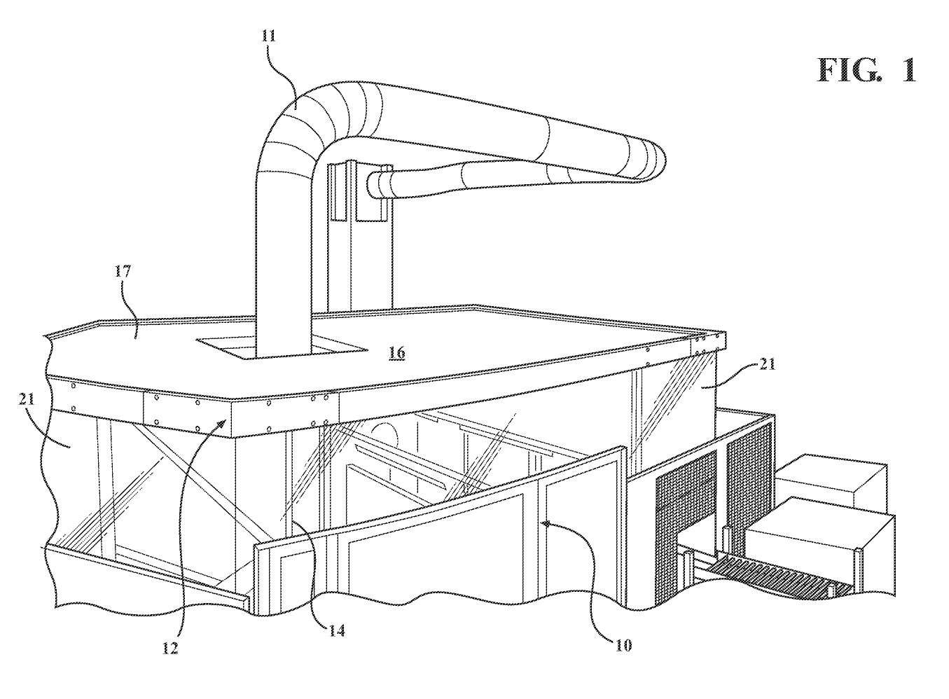

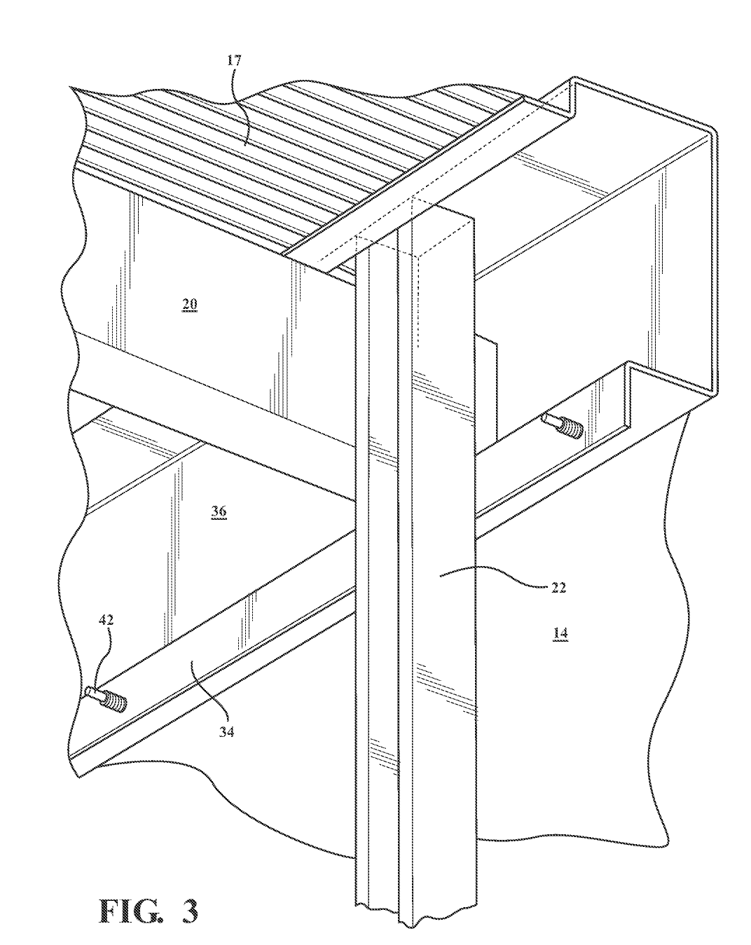

With reference to FIG. 1, the hood 16 is defined by front, back and side rails 12. With reference to FIG. 3, the cross-supports 20 and vertical-supports 22 are shown. As can be seen, the cross-supports 20 and vertical-supports 22 are received within channels formed by the profile of the rails 12. The cross-supports 20 provide support to the hood 16 and provide support for lights, etc. which can be suspended from the cross-supports 20. A guarding wall panels or side curtain or similar structure 21 can hang from the rails to complete the enclosure of the work station 10.

The vertical supports 22 support the hood above the floor of the work station. They can extend all the way to the floor or be attached to supports extending from the floor, or connect to the existing guarding wall panels that are around the robot cell.

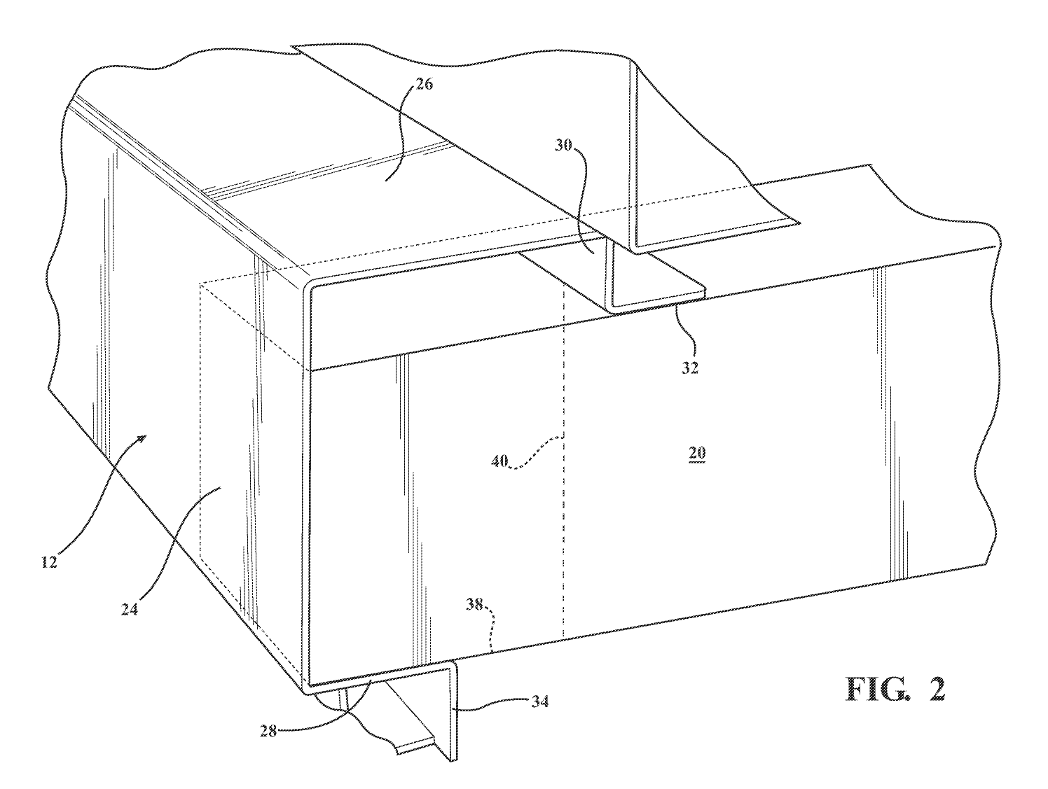

With reference to FIG. 2, the rails 12 have a top wall 26 and side wall 24 and bottom wall 28. The rails 12 have a multi-purpose profile. Wall 26 is longer than wall 28 by a width 38 (shown by the dotted line) of about the width of vertical-supports 22. The wall 26 ends in an inwardly extending flange 30 that ends in a lip 32. The wall 28 ends in an outwardly extending flange 34. The walls 26 and 28 define a channel 36 which has a narrowed entrance 40 (shown by the dotted line) defined by the inwardly extending flange 30 and the lip 32 and the bottom wall 28. The narrowed entrance 40 is about the width of the cross-support 20. The wall 28 and the lip 32 define a pocket for receipt of the cross-support 20. The sides of the cross-support 20 fit between and in the desired embodiment engage the wall 28 and lip 32. In the preferred embodiment, the cross-support 20 is inserted between the wall 28 and lip 32 and supported by the wall 28 and lip 32 as shown in FIG. 3. If desired, sheet metal screws or similar attachments could be used for further support. The vertical-supports 22 are received between the flange 34 and the inwardly extending flange 30. The vertical-supports 22 fit between and in the desired embodiment, engage and are supported by the flange 34 and the inwardly extending flange 30. If desired, sheet metal screws or similar attachments could be used for further support.

The lip 32 supports the ceiling 17, which in the disclosed embodiment is transparent to allow in light to the enclosed work station 10. Cross ceiling supports can be used to add additional support to the ceiling 17. The outwardly extending flange 34 supports the side curtains 14, which in the disclosed embodiment are attached with sheet metal screws 42.

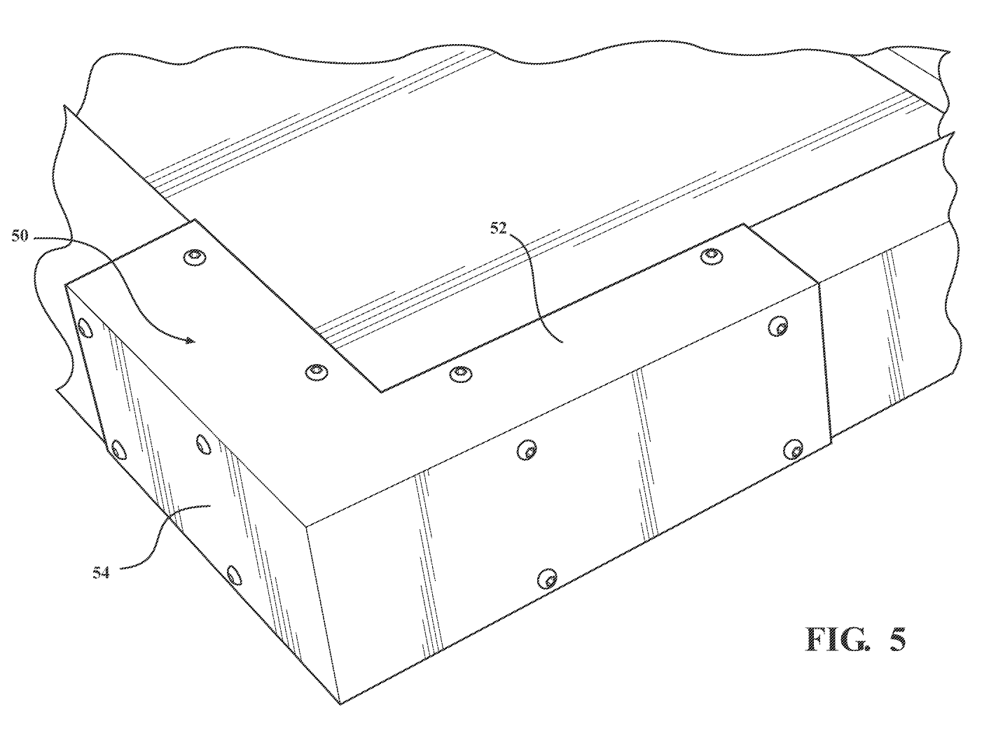

With reference to FIG. 5, the hood 16 is illustrated with the corner brackets 50 for connecting the rails 12 together to form the hood 16. The corner brackets 50 are generally L-shaped with a top 52 and sides 54. The top 52 and sides 54 engage the walls 26 and 24. As illustrated, sheet metal screws are used to connect the corner brackets 50 to the rails 12.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A workstation structure comprising:
a hood, vertical supports and cross supports;
said hood having at least two opposed rails with each rail having a multi-purpose profile;
said multi-purpose profile being generally U-shaped with a top wall, a side wall, and a bottom wall;
a top flange extends generally perpendicular to said top wall and a bottom flange extends generally perpendicular to said bottom wall, said top flange and bottom flange extend generally parallel to one another and are spaced apart by a first distance;
a lip extends generally perpendicular to said flange, said lip is generally parallel to said bottom wall and is spaced from said bottom wall by a second distance;
said vertical supports have a width that is generally equal to said first distance such that said vertical supports are received between said top flange and said bottom flange;
said cross supports have a width generally equal to said second distance such that said cross supports are received between said lip and said bottom wall;
whereby said workstation structure can be easily assembled by inserting said vertical support between said top flange and said bottom flange and inserting said cross supports between said lip and said bottom wall.

2. The workstation structure of claim 1, wherein said at least two rails having said multi-function profile can be nested one within the other;
whereby transportation is made easier.

3. The workstation structure of claim 1, further including corner members, each of said rails having free ends, each of said corner members joining adjacent free ends of said rails.

4. The workstation structure of claim 1, further including a ceiling member, said ceiling member supported by said lip.

5. The workstation structure of claim 1, further including side curtains.

6. The workstation structure of claim 1, wherein said hood has four rails defining the outer perimeter of said hood, all of said rails have a unitary multi-function profile.

7. A streamlined hood for a workstation, said hood comprising:
four rails with at least two rails have a unitary multi-function profile;
said multi-purpose profile being generally U-shaped with a top wall, a side wall, and a bottom wall;
a top flange extends generally perpendicular to said top wall and a bottom flange extends generally perpendicular to said bottom wall, said top flange and bottom flange extend generally parallel to one another and are spaced apart be a first distance;
a lip extends generally perpendicular to said flange, said lip is generally parallel to said bottom wall and is spaced from said bottom wall be a second distance.

8. The streamlined hood for a workstation of claim 7, wherein said at least two rails having said multi-function profile can be nested one within the other;
whereby transportation is made easier.

9. The streamlined hood for a workstation of claim 7, further including corner members, each of said rails having free ends, each of said corner members joining adjacent free ends of said rails.

10. The streamlined hood for a workstation of claim 7, further including a ceiling member, said ceiling member supported by said lip.

11. The streamlined hood for a workstation of claim 7, further including vertical supports, said vertical supports have a width that is generally equal to said first distance such that said vertical supports are received between said top flange and said bottom flange.

12. The streamlined hood for a workstation of claim 7, further including cross supports, said cross supports have a width generally equal to said second distance such that said cross supports are received between said lip and said bottom wall.
